(19) United States
(12) Patent Application Publication
(10) Pub. No.: US 2025/0239254 A1
(43) Pub. Date: Jul. 24, 2025

(54) METHOD AND APPARATUS FOR MULTILINGUAL SPEECH RECOGNITION

(71) Applicant: SAMSUNG ELECTRONICS CO., LTD., Suwon-si (KR)

(72) Inventors: Kyungmin LEE, Suwon-si (KR); Haeri KIM, Suwon-si (KR); Jinhwan PARK, Suwon-si (KR); Hyeongmin OH, Suwon-si (KR)

(73) Assignee: SAMSUNG ELECTRONICS CO., LTD., Suwon-si (KR)

(21) Appl. No.: 19/008,332

(22) Filed: Jan. 2, 2025

Related U.S. Application Data
(63) Continuation of application No. PCT/KR2024/016938, filed on Oct. 31, 2024.

(30) Foreign Application Priority Data
Jan. 24, 2024 (KR) 10-2024-0011061
Jun. 27, 2024 (JP) 10-2024-0084463

(51) Int. Cl. G10L 15/00; G06F 40/279; G10L 15/22

(52) U.S. Cl. CPC G10L 15/005; G06F 40/279; G10L 15/22

(57) ABSTRACT

A method and apparatus for multilingual speech recognition are provided. The method includes: determining a language homogeneity score (LHS) of a target token based on a language identification result of the target token, wherein the target token is obtained as a speech recognition result of input speech data; and identifying text data corresponding to the input speech data based on the LHS of the target token and a probability that the target token corresponds to the input speech data.

### CROSS-REFERENCE TO RELATED APPLICATIONS

This application is a bypass-continuation of International Application No. PCT/KR2024/016938, filed on Oct. 31, 2024, which is based on and claims priority to Korean Patent Application No. 10-2024-0011061, filed in the Korean Intellectual Property Office on Jan. 24, 2024, and Korean Patent Application No. 10-2024-0084463, filed in the Korean Intellectual Property Office on Jun. 27, 2024, the disclosures of which are incorporated herein by reference in their entireties.

### BACKGROUND

### 1. Field

The present disclosure relates to multilingual speech recognition

### 2. Description of the Related Art

Speech recognition technology is technology that converts and processes a speech signal generated by utterance into text data and is also referred to as speech-to-text (STT). Speech becomes available as an input method of an apparatus due to speech recognition technology so that speech recognition technology is being applied to various technology fields such as an information search and device control through speech. Recently, research on a speech recognition algorithm using machine learning to improve the performance of speech recognition and research to supplement the application of speech recognition technologies, such as technology to separate speech for each speaker from a speech signal including speech of speakers and technology to identify a speaker from a speech signal, are being actively conducted.

### SUMMARY

Provided is a technique for improving the accuracy of speech recognition of a multilingual speech recognition model through the introduction of a condition for maintaining the consistency of language of tokens. However, the disclosure is not limited to the aforementioned aspects, and other technical aspects may be present.

According to an aspect of the disclosure, a multilingual speech recognition method includes: determining a language homogeneity score (LHS) of a target token based on a language identification result of the target token, wherein the target token is obtained as a speech recognition result of input speech data; and identifying text data corresponding to the input speech data based on the LHS of the target token and a probability that the target token corresponds to the input speech data.

The identifying the text data corresponding to the input speech data may include: determining an automatic speech recognition (ASR) score of the target token based on the probability that the target token corresponds to the input speech data; correcting the ASR score of the target token based on the LHS of the target token; and identifying the text data corresponding to the input speech data based on the ASR score of the target token.

The determining the LHS of the target token may include determining the LHS of the target token based on a degree of similarity between the language identification result of the target token and a language identification result of a token sequence prior to the target token.

The determining the LHS of the target token may include determining the LHS of the target token based on a degree of similarity between the language identification result of the target token and a language identification result of the input speech data.

The determining the LHS of the target token may include: determining a parameter regarding a proportion of the LHS of the target token based on a language change probability corresponding to the target token; and correcting the LHS of the target token based on the parameter.

The parameter may decrease as the language change probability of the target token increases.

According to an aspect of the disclosure, a multilingual speech recognition method includes: obtaining pieces of candidate text data corresponding to input speech data based on a speech recognition result of the input speech data; determining a language homogeneity score (LHS) of each of the pieces of candidate text data based on a degree of similarity between language identification results of a plurality of tokens included in the pieces of candidate text data; and identifying, based on the LHSs of the pieces of candidate text data, one or more pieces of candidate text data corresponding to the input speech data from among the pieces of candidate text data.

The determining the LHS of each of the pieces of candidate text data may include: determining, for each of the plurality of tokens included in the pieces of candidate text data, an LHS of the token; and determining the LHS of each of the pieces of candidate text data based on a sum of the LHSs of the plurality of tokens.

The determining the LHS of each of the plurality of tokens may include determining, for each of the plurality of tokens, an LHS of the token based on a degree of similarity between a language identification result of the token and a language identification result of a token sequence prior to the token.

The determining the LHSs of each of the plurality of tokens may include determining, for each of the plurality of tokens, an LHS of the token based on a degree of similarity between a language identification result of the token and a language identification result of the input speech data.

The identifying the one or more pieces of candidate text data corresponding to the input speech data may include identifying, among the pieces of candidate text data, the one or more pieces of candidate text data corresponding to the input speech data based on respective probabilities that each of the pieces of candidate text data corresponds to the input speech data and the respective LHS of each of the pieces of candidate text data.

The determining the LHS of each of the pieces of candidate text data may include: determining, for each of the pieces of candidate text data, a parameter regarding a proportion of the LHS of the piece of candidate text data based on a language change probability corresponding to each token of the plurality of tokens included in the piece of candidate text data; and correcting the LHS of each of the pieces of candidate text data based on the determined parameters.

The parameter corresponding to a given piece of candidate text data among the pieces of candidate text data may decrease as the language change probability of each token of the plurality of tokens included in the given piece of candidate text data increases.

According to an aspect of the disclosure, a non-transitory computer-readable storage medium has instructions stored therein, which when executed by at least one processor, cause the at least one processor to execute a multilingual speech recognition method including: determining a language homogeneity score (LHS) of a target token based on a language identification result of the target token, wherein the target token is obtained as a speech recognition result of input speech data; and identifying text data corresponding to the input speech data based on the LHS of the target token and a probability that the target token corresponds to the input speech data.

According to an aspect of the disclosure, a multilingual speech recognition apparatus includes: at least one memory storing one or more instructions; and at least one processor configured to execute the one or more instructions, wherein the one or more instructions, when executed by the at least one processor, cause the multilingual speech recognition apparatus to: determine a language homogeneity score (LHS) of a target token based on a language identification result of a target token obtained as a speech recognition result of input speech data, and identify text data corresponding to the input speech data based on the LHS of the target token and a probability that the target token corresponds to the input speech data.

The one or more instructions, when executed by the at least one processor, may cause the multilingual speech recognition apparatus to, in the identification of the text data corresponding to the input speech data: determine an automatic speech recognition (ASR) score of the target token based on the probability that the target token corresponds to the input speech data, correct the ASR score of the target token based on the LHS of the target token, and identify the text data corresponding to the input speech data based on the ASR score of the target token.

The one or more instructions, when executed by the at least one processor, may cause the multilingual speech recognition apparatus to, in the determination of the LHS of the target token, determine the LHS of the target token based on a degree of similarity between the language identification result of the target token and a language identification result of a token sequence prior to the target token.

The one or more instructions, when executed by the at least one processor, may cause the multilingual speech recognition apparatus to, in the determination of the LHS of the target token, determine the LHS of the target token based on a degree of similarity between the language identification result of the target token and a language identification result of the input speech data.

The one or more instructions, when executed by the at least one processor, may cause the multilingual speech recognition apparatus to, in the determination of the LHS of the target token: determine a parameter regarding a proportion of the LHS of the target token, based on a language change probability corresponding to the target token, and correct the LHS of the target token based on the parameter.

According to an aspect of the disclosure, a non-transitory computer-readable storage medium has instructions stored therein, which when executed by at least one processor, cause the at least one processor to execute a multilingual speech recognition method including: obtaining pieces of candidate text data corresponding to input speech data based on a speech recognition result of the input speech data; determining a language homogeneity score (LHS) of each of the pieces of candidate text data based on a degree of similarity between language identification results of a plurality of tokens included in the pieces of candidate text data; and identifying, based on the LHSs of the pieces of candidate text data, one or more pieces of candidate text data corresponding to the input speech data from among the pieces of candidate text data.

According to an aspect of the disclosure, a multilingual speech recognition apparatus includes: at least one memory storing one or more instructions; and at least one processor configured to execute the one or more instructions, wherein the one or more instructions, when executed by the at least one processor, cause the multilingual speech recognition apparatus to: obtain pieces of candidate text data corresponding to input speech data based on a speech recognition result of the input speech data, determine a language homogeneity scores (LHSs) of each of the pieces of candidate text data based on a degree of similarity between language identification results of a plurality of tokens included in the pieces of candidate text data, and identify, based on the LHSs of the pieces of candidate text data, one or more pieces of candidate text data corresponding to the input speech data from among the pieces of candidate text data.

### BRIEF DESCRIPTION OF THE DRAWINGS

The above and other aspects and features of certain embodiments of the present disclosure will be more apparent the following description taken in conjunction with the accompanying drawings, in which:

FIG. 1 is a flowchart illustrating an operation of a multilingual speech recognition method, according to one or more embodiments;

FIGS. 2A and 2B are diagrams illustrating a language identification result of a token, according to one or more embodiments;

FIGS. 3A and 3B are diagrams illustrating a language homogeneity score (LHS) L_{T} graph determined based on a language identification result of a token, according to one or more embodiments;

FIGS. 4A and 4B are diagrams illustrating an LHS L_{T} graph determined based on a language identification result of a token and a language identification result of speech data, according to one or more embodiments;

FIG. 5 is a flowchart illustrating an operation of a multilingual speech recognition method, according to one or more embodiments;

FIG. 6 is a diagram illustrating an operation of determining a language recognition result based on an automatic speech recognition (ASR) score and an LHS, according to one or more embodiments;

FIG. 7 is a block diagram illustrating an operation of a multilingual speech recognition apparatus, according to one or more embodiments;

FIG. 8 is a block diagram illustrating an operation of an LHS module, according to one or more embodiments; and

FIG. 9 is a diagram illustrating an example of a configuration of a multilingual speech recognition apparatus, according to one or more embodiments.

### DETAILED DESCRIPTION

The following detailed structural or functional description is provided as an example only and various alterations and modifications may be made to the embodiments described herein. Accordingly, the embodiments described herein should not be construed as limited to the disclosure, but should be understood to include all changes, equivalents, and replacements within the idea and the technical scope of the disclosure.

In connection with the description of the drawings, like reference numerals may be used for similar or related components. It is to be understood that a singular form of a noun corresponding to an item may include one or more of the things, unless the relevant context clearly indicates otherwise.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Terms, such as “first” or “second”, are simply used to distinguish a component from another component and do not limit the components in other aspects (e.g., importance or sequence).

It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., by wire), wirelessly, or via a third element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

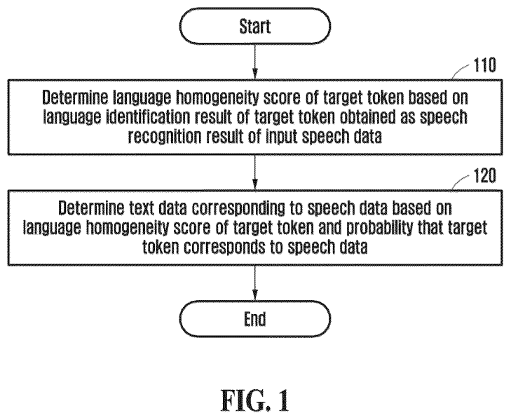

FIG. 1 is a flowchart illustrating an operation of a multilingual speech recognition method, according to one or more embodiments.

According to one or more embodiments, the multilingual speech recognition method may include a method of converting speech data into text data. The multilingual speech recognition method may include a method of recognizing speech data that is uttered in a plurality of languages and converting the speech data into text data.

According to one or more embodiments, the multilingual speech recognition method may be implemented as a multilingual speech recognition model capable of recognizing a plurality of languages. For example, a multilingual speech recognition model that recognizes English and Korean may output data converted from speech data into Korean text when input speech data is speech data that is uttered in Korean and may output data converted from speech data into English text when input speech data is speech data that is uttered in English.

The multilingual speech recognition method may be performed by an apparatus that executes the multilingual speech recognition model. The multilingual speech recognition apparatus that executes the multilingual speech recognition method is described in detail below.

According to one or more embodiments, the multilingual speech recognition method may include, determining a language homogeneity score (LHS) of a target token based on a language identification result of the target token obtained as a speech recognition result of input speech data.

A token is a unit of data output as a speech recognition result, and the multilingual speech recognition model may output the speech recognition result in a token unit. The token may correspond to text data corresponding to a portion of speech data. Tokens output in response to input speech data may correspond to time series data. The target token may correspond to any one of a plurality of tokens output as a speech recognition result of speech data.

The LHS of a token is an indicator of whether a language of the token is similar to a language of another token and may be determined to be a higher value as a degree of similarity between the language of the token and the language of the other token increases.

According to one or more embodiments, operation 110 of determining an LHS of a target token may include determining the LHS of the target token based on a similarity between a language identification result of the target token and a language identification result of a token sequence prior to the target token.

The token sequence prior to the target token may correspond to a sequence including one or more consecutive tokens before the target token when tokens are listed in chronological order. For example, when the target token is an i-th token, the token sequence prior to the target token may correspond to a sequence including an i−1-th token, starting from a j-th token (j is any natural number that is less than i).

The language identification result of the target token may include the probability that the target token corresponds to each of a plurality of languages. The plurality of languages may include languages that may be recognized by the multilingual speech recognition model. For example, the language identification result of the target token may correspond to a vector including the probability that the target token corresponds to English and the probability that the target token corresponds to Korean.

The LHS of the target token may be determined to be a higher value as a degree of similarity between the language identification result of the target token and the language identification result of the token sequence prior to the target token increases.

For example, an LHS L_{T}[i] of the i-th token may be determined as shown in Equation 1 below.

$${L}_{T} [ i ] = sim ( merge ( M [ j ] , … , M [ i - 1 ] ) , M [ i ] ) \qquad Equation 1$$

In Equation 1, M[x] denotes a language identification result of an x-th token and may correspond to a vector including the probability that the x-th token corresponds to each of a plurality of languages. The term sim(x, y) denotes a similarity between x and y and may correspond to, for example, a calculated value of a cosine similarity. The term merge (M[j], . . . , M[i−1]) denotes an operation to sum of M[j] to M[i−1] and may correspond to, for example, a weighted average of M[j] to M[i−1]. The term merge (M[j], . . . , M[i−1]) denotes a result of an operation to sum language identification results from the j-th token (j is any natural number that is less than i) to the i−1-th token, which may also be represented as M[j:i]. That is, the LHS L_{T}[i] of the i-th token may be determined based on a similarity between a weighted average of language identification results of tokens prior to the i-th token and a language identification result of the i-th token.

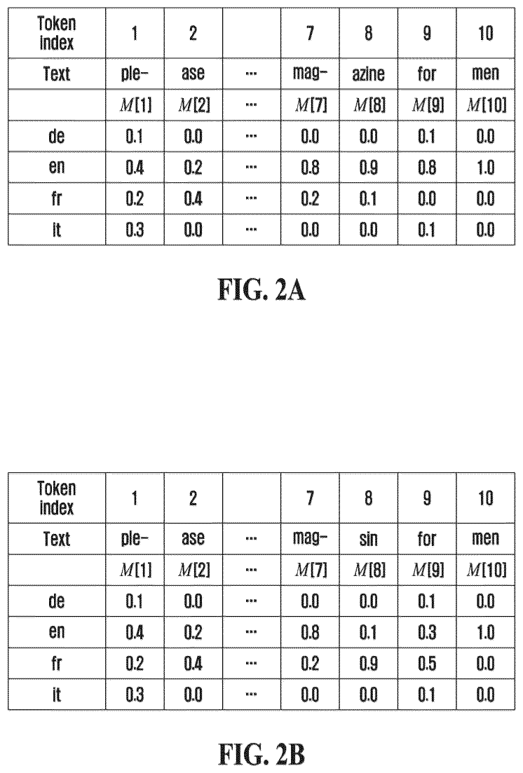

For example, FIG. 2A shows text data (row 2) of each token and language identification results (rows 3 to 7) of each token. The language identification results of each token may include probabilities that each token corresponds to German (de), English (en), French (fr), and Italian (it). When an 8th token is “azine,” a language identification result M[8] of the 8th token may include a value of 0, which is the probability that the 8th token corresponds to German, a value of 0.9, which is the probability that the 8th token corresponds to English, a value of 0.1, which is the probability that the 8th token corresponds to French, and a value of 0, which is the probability that the 8th token corresponds to Italian. The language identification result M[8] of the 8th token may indicate that the 8th token has the highest probability of corresponding to English.

The LHS of an i-th token may be determined based on a similarity between a language identification result M[i] of the i-th token and a language identification result M[j:i−1] (j is any natural number that is less than i) of a token sequence prior to the i-th token. For example, when there are many tokens with the highest probability of corresponding to English as the language identification results of first to seventh tokens, which are tokens prior to the 8th token, the degree of similarity between the language identification result of the 8th token and the language identification result of the token sequence prior to the 8th token may be determined to be high. In this case, the LHS of the 8th token may be determined to be a high value.

For example, referring to FIG. 2B, when the 8th token is “sin,” the language identification result M[8] of the 8th token may include a value of 0, which is the probability that the 8th token corresponds to German, a value of 0.1, which is the probability that the 8th token corresponds to English, a value of 0.9, which is the probability that the 8th token corresponds to French, and a value of 0, which is the probability that the 8th token corresponds to Italian. Unlike the example shown in FIG. 2A, the language identification result M[8] of the 8th token may indicate that the 8th token has the highest probability of corresponding to French.

When there are many tokens with the highest probability of corresponding to English as the language identification results of the first to seventh tokens, which are the tokens prior to the 8th token, a degree of similarity between the language identification result of the 8th token and the language identification result of the token sequence prior to the 8th token may be determined to be low. In this case, the LHS of the 8th token may be determined to be a low value.

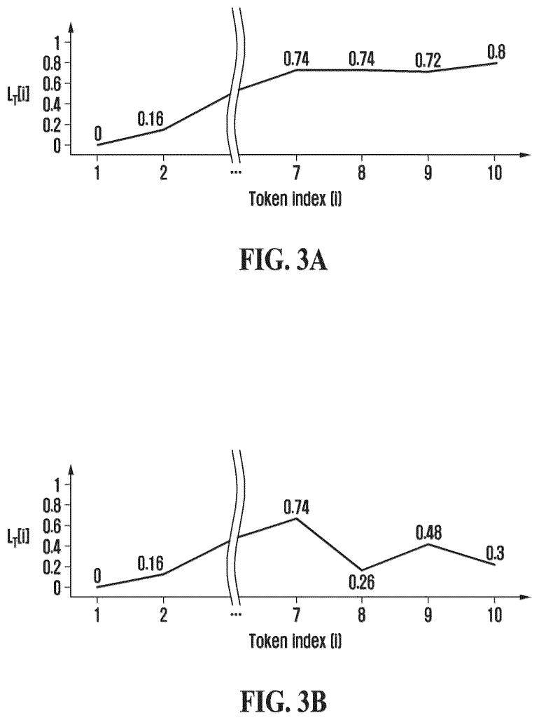

FIG. 3A illustrates an LHS L_{T} graph of each token determined based on language identification results M of each token shown in FIG. 2A. FIG. 3B illustrates an LHS L_{T} graph of each token determined based on language identification results M of each token shown in FIG. 2B. Referring to FIG. 3A, when an 8th token is “azine,” an LHS L_{T}[8] of the 8th token may be determined to be 0.74. Moreover, referring to FIG. 3B, when the 8th token is “sin,” the LHS L_{T}[8] of the 8th token may be determined to be 0.26.

According to one or more embodiments, operation 110 of determining the LHS of the target token may include determining the LHS of the target token based on a degree of similarity between the language identification result of the target token and a language identification result of speech data corresponding to the target token. The language identification result of the speech data may include a determination of which language corresponds to the input speech data. For example, the language identification result of the speech data may be obtained by a separate language identification model. For example, the language identification result of the speech data may correspond to data (e.g., a one-hot vector) indicating a language corresponding to the speech data. For example, the language identification result of the speech data may correspond to a vector including the probability that the speech data corresponds to each of a plurality of languages.

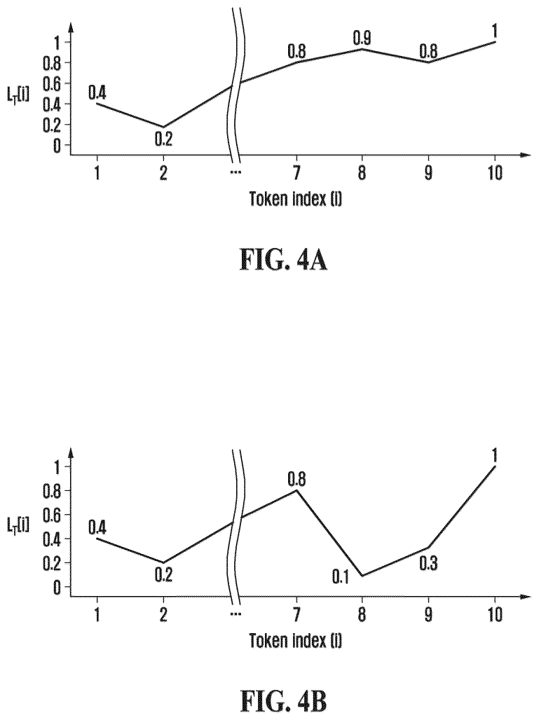

For example, when the language identification result of the speech data includes a value of 0, which is the probability of corresponding to German, a value of 1, which is the probability of corresponding to English, a value of 0, which is the probability of corresponding to French, and a value of 0, which is the probability of corresponding to Italian, the LHS L_{T} of each token may be determined as the graph illustrated in FIG. 4A based on the degree of similarity between the language identification results M of each token illustrated in FIG. 2A and the language identification result of the speech data. In addition, the LHS L_{T} of each token may be determined as the graph illustrated in FIG. 4B based on the degree of similarity between the language identification results M of each token illustrated in FIG. 2B and the language identification result of the speech data. Referring to FIG. 4A, when the 8th token is “azine,” the LHS L_{T}[8] of the 8th token may be determined to be 0.9. Moreover, referring to FIG. 4B, when the 8th token is “sin,” the LHS L_{T}[8] of the 8th token may be determined to be 0.1.

According to one or more embodiments, operation 110 of determining the LHS of the target token may include determining a parameter regarding a proportion of the LHS of the target token, based on a language change probability corresponding to the target token, and correcting the LHS of the target token based on the parameter.

The language change probability corresponding to the target token may correspond to the probability that the language corresponding to the target token is different from a language corresponding to another token. For example, when the speech data is “ [symbol] [symbol] Bruno Mars [symbol] ,” the language change probability of a token corresponding to “Bruno Mars” in English may be determined to be a high value, unlike a token corresponding to other speech data in Korean.

The parameter regarding the proportion of the LHS of the target token may be determined to be a lesser value as the language change probability of the target token increases. For example, the parameter regarding the proportion of the LHS of the target token may be determined to be an inverse number of the language change probability of the target token.

According to one or more embodiments, the language change probability of the target token may be obtained by a model that estimates the language change probability of a token. For example, the model that estimates the language change probability of the token may be an n-gram model. For example, the model that estimates the language change probability of the token may be a neural network trained to estimate the language change probability.

For example, the language change probability of the target token may be obtained using a language model (e.g., a count-based language model such as an n-gram-based language model, a training-based language model, etc.) used for speech recognition. For example, the language change probability of the target token may be obtained using a prediction network of a speech recognition model with a transducer structure or a decoder of a speech recognition model with a transformer structure.

For example, the probability that an i-th token is a certain language may be obtained as P(lᵢ|w₀:wᵢ₋₁)=sum_{w}_{ₗ}ᵢₙₗ_{ᵢ}P(wₗ|w₀:wᵢ₋₁). P(wₗ|w₀:wᵢ₋₁)may correspond to the probability of a language model. The probability of the language model may be a value indicating the probability that wₗ appears next to a given token sequence w₀:wᵢ₋₁ in a training corpus. wₗ may refer to a token corresponding to a certain language l. For example, the certain language may be English, and a probability P(lᵢ|w₀:wᵢ₋₁)that the i-th token is English may be determined as the sum of probabilities P(wₗ|w₀:wᵢ₋₁)of the language model for each token wₗ corresponding to English.

For example, the probability of the language model may be determined to be an appropriate probability value even for an unseen context.

When the probability of the language model corresponding to a token decreases rapidly, a token with increasing entropy may be determined to be a token with a high language change probability. The increase in entropy may indicate that the probability of the language model corresponding to a certain token has a lower value than the probability of a language model corresponding to a preceding token with a low probability.

For example, an LHS L_{T}[i] of the i-th token may be determined as in Equation 2 below.

$${L}_{T} [ i ] = sim ( merge ( M [ j ] , … M [ i - 1 ] ) , M [ i ] ) α [ i ] ) \qquad Equation 2$$

In Equation 2, α[i] may correspond to the parameter regarding the proportion of the LHS of the i-th token.

For example, when the speech data is data in which a sentence including English words in the middle of a sentence corresponding to Korean, such as “ [symbol] Bruno Mars [symbol] ,” is uttered, the language change probability of a token corresponding to “Bruno Mars” in English may be determined to be a high value by an n-gram model, etc., unlike a token corresponding to the other speech data in Korean. The parameter α[i] regarding the proportion of the LHS of a token i corresponding to “Bruno Mars” with a high language change probability may be determined to be a less value than that of the other token. The proportion in which the LHS is reflected in the final score for determining whether to determine the token i to be a speech recognition result by the parameter α[i] regarding the language proportion may be less than the proportion of an automatic speech recognition (ASR) score. By lowering the proportion of the LHS of a token with a high language change probability through a parameter regarding a language proportion, the token corresponding to the language that is different from the language of the other token may be determined to be the speech recognition result.

According to one or more embodiments, a multilingual speech recognition method may include operation 120 of determining text data corresponding to the speech data, based on the LHS of the target token and a probability that the target token corresponds to the speech data. The probability that the target token corresponds to the speech data may be a probability that the target token determined based on pronunciation in an ASR module of a multilingual speech recognition model corresponds to a speech recognition result of the speech data.

According to one or more embodiments, operation 120 of identifying the text data corresponding to the speech data may include determining an ASR score of the target token based on the probability that the target token corresponds to the speech data, correcting the ASR score of the target token based on the LHS of the target token, and identifying the text data corresponding to the speech data, based on the ASR score of the target token.

The ASR score of the target token may be determined by the probability of which text the target token corresponds to, based on the pronunciation of the speech data. The ASR score may be determined by the speech recognition result output from the ASR module of the multilingual speech recognition model.

For example, the ASR score of the target token may be corrected by a sum, a weighted sum, an average, or a weighted average of the ASR score and the LHS of the target token. For example, a corrected ASR score ASR_{T}′[i] of the i-th token may be determined as in Equation 3 below.

$${ASR}_{T}^{′} [ i ] = {ASR}_{T} [ i ] \times λ + {L}_{T} [ i ] \qquad Equation 3$$

In Equation 3, ASR_{T}′[i] denotes an ASR score of the i-th token, L_{T}[i] denotes an LHS of the i-th token, and λ denotes a weight of ASR_{T}′[i]. ASR_{T}′[i] denotes a corrected ASR score of the i-th token.

The text data corresponding to the speech data may be determined based on the corrected ASR score. Among candidates of the i-th token, a candidate of the i-th token having the highest corrected ASR score may be determined to be the text data corresponding to the speech data. For example, referring to FIGS. 3A and 3B, when an ASR score for a case in which the 8th token is “azine” is similar to an ASR score for a case in which the 8th token is “sin,” the LHS L_{T}[8] when the 8th token is “azine” is 0.74, which is higher than 0.26 of the LHS L_{T}[8] when the 8th token is “sin,” so the corrected ASR score may be determined to be a higher value when the 8th token is “azine” than when the 8th token is “sin.” For example, when the 8th token is “sin,” the corrected ASR score may be determined to be 0.7, and when the 8th token is “azine,” the corrected ASR score may be determined to be 0.9. Since the corrected ASR score is higher when the 8th token is “azine” than when the 8th token is “sin,” the text data including “azine” as the 8th token may be determined to be the text data corresponding to the speech data. That is, the text data including “azine” as the 8th token may be output as the speech recognition result of the speech data.

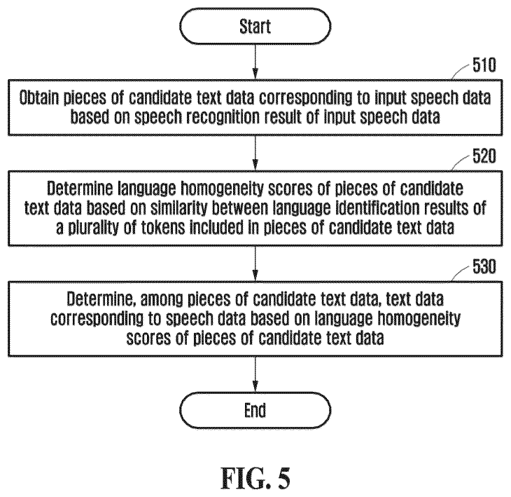

FIG. 5 is a flowchart illustrating an operation of a multilingual speech recognition method, according to one or more embodiments.

The multilingual speech recognition method described above with reference to FIG. 1 may correspond to a method of determining a speech recognition result based on a language identification result at a token level, and the multilingual speech recognition method described with reference to FIG. 5 may correspond to a method of determining a speech recognition result based on a language identification result at a token sequence level. As described above, the token sequence may correspond to a sequence including one or more consecutive tokens when tokens output as a speech recognition result of speech data are listed in chronological order.

Referring to FIG. 5, according to one or more embodiments, the multilingual speech recognition method may include operation 510 of obtaining pieces of candidate text data corresponding to input speech data, based on a speech recognition result of the input speech data. The pieces of candidate text data may correspond to the token sequence including one or more consecutive tokens.

The pieces of candidate text data may be obtained as the speech recognition result of the input speech data. At least some tokens of the pieces of candidate text data may be different from each other. For example, first candidate text data of “Please recommend me a magazine for men” and second candidate text data of “Please recommend me a magasin for men” may be obtained as a speech recognition result of speech data in which “Please recommend me a magazine for men” is uttered. For example, the pieces of candidate text data may correspond to the speech recognition result of the speech data determined based on pronunciation in an ASR module of a multilingual speech recognition model.

According to one or more embodiments, the multilingual speech recognition method may include operation 520 of determining LHSs of the pieces of candidate text data based on a similarity between language identification results of a plurality of tokens included in the pieces of candidate text data.

According to one or more embodiments, operation 520 of determining the LHSs of the pieces of candidate text data may include determining LHSs of each of the plurality of tokens included in the pieces of candidate text data and determining the LHSs of the pieces of candidate text data based on the sum of the LHSs of each of the plurality of tokens. For example, the LHSs of the pieces of candidate text data may be determined as a sum, a weighted sum, an average, or a weighted average of the LHSs of each of the plurality of tokens included in the pieces of candidate text data. For example, the LHSs of the pieces of candidate text data may be determined to be a value obtained by converting the sum or the weighted sum of the LHSs of each of the plurality of tokens included in the pieces of candidate text data.

According to one or more embodiments, the determining of the LHSs of each of the plurality of tokens may include determining an LHS of a token based on a similarity between a language identification result of the token included in the plurality of tokens and a language identification result of a token sequence prior to the token. For example, the LHS of the token may be determined by Equation 1.

According to one or more embodiments, the determining of the LHSs of each of the plurality of tokens may include determining the LHS of the token based on a degree of similarity between the language identification result of the token included in the plurality of tokens and a language identification result of speech data corresponding to the plurality of tokens.

For example, an LHS L_{S} of the candidate text data may be determined as in Equation 4 below.

$${L}_{S} = \frac{1}{I} {\sum }_{i} {L}_{T} [ i ] \qquad Equation 4$$

In Equation 4, I denotes the length of a token of the candidate text data or the number of tokens included in the candidate text data. For example, L_{T}[i] denotes an LHS of an i-th token included in the candidate text data determined by Equation 1. For example, L_{T}[i] may be determined based on a similarity between a language identification result of speech data corresponding to data (e.g., a one-hot vector) indicating a language corresponding to the speech data and a language identification result of the i-th token. That is, the LHS L_{S} of the candidate text data may correspond to the average of the LHSs of the tokens included in the candidate text data.

According to one or more embodiments, operation 520 of determining the LHSs of the pieces of candidate text data may include determining a parameter regarding a proportion of the LHSs of the pieces of candidate text data, based on a language change probability determined corresponding to each of the tokens included in the pieces of candidate text data, and correcting the LHSs of the pieces of candidate text data based on the parameter.

The parameter regarding a proportion of the LHSs of the pieces of candidate text data may be determined to be a lesser value as the language change probability of the tokens included in the pieces of candidate text data increases. For example, the parameter regarding a proportion of the LHSs of the pieces of candidate text data may be determined as a sum, a weighted sum, a product, an average, or an inverse number of a weighted average of the language change probabilities of each of the tokens included in the pieces of candidate text data. For example, the parameter regarding a proportion of the LHSs of the pieces of candidate text data may be determined to be a value obtained by converting a product, a sum, or an inverse number of a weighted sum of the language change probabilities of each of the tokens included in the pieces of candidate text data.

For example, the LHS L_{S} of the candidate text data may be determined as in Equation 5 below.

$${L}_{S} = \frac{1}{I} {\sum }_{i} {L}_{T} [ i ] \times β \qquad Equation 5$$

In Equation 5, I denotes the length of a token of the candidate text data or the number of tokens included in the candidate text data, L_{T}[i] denotes the LHS of the i-th token included in the candidate text data, and β denotes the parameter regarding the proportion of the LHS of the candidate text data. For example, β may be determined as a product of parameters regarding the proportion of the LHSs of the tokens included in the candidate text data.

According to one or more embodiments, the multilingual speech recognition method may include operation 530 of determining, among the pieces of candidate text data, text data corresponding to the speech data, based on the LHSs of the pieces of candidate text data.

According to one or more embodiments, operation 530 of identifying the text data corresponding to the speech data may include determining, among the pieces of candidate text data, the text data corresponding to the speech data, based on the probability that the pieces of candidate text data correspond to the speech data and LHSs of the pieces of candidate text data. The probability that the pieces of candidate text data correspond to the speech data may be the probability that the pieces of candidate text data, which are determined based on pronunciation in the ASR module of a multilingual speech recognition model, correspond to the speech recognition result of the speech data. For example, the probability that the pieces of candidate text data correspond to the speech data may be determined based on the probability that each token included in the pieces of candidate text data corresponds to the speech data.

According to one or more embodiments, operation 530 of identifying the text data corresponding to the speech data may include determining ASR scores of the pieces of candidate text data based on the probability that the pieces of candidate text data correspond to the speech data, correcting the ASR scores of the pieces of candidate text data based on the LHSs of the pieces of candidate text data, and identifing the text data corresponding to the speech data, based on the ASR scores of the pieces of candidate text data.

The ASR scores of the pieces of candidate text data may be determined based on the probability of which text the pieces of candidate text data correspond to, based on the pronunciation of the speech data. The ASR scores may be determined by the speech recognition result output from the ASR module of the multilingual speech recognition model. For example, the ASR scores of the pieces of candidate text data may be determined based on the probability that each token included in the pieces of candidate text data corresponds to the speech data or the ASR score of each token included in the pieces of candidate text data. For example, the ASR scores of the pieces of candidate text data may be corrected by a sum, a weighted sum, an average, or a weighted average of the ASR scores of the pieces of candidate text data and the LHSs of the pieces of candidate text data.

The text data corresponding to the speech data may be determined based on the corrected ASR scores of the pieces of candidate text data.

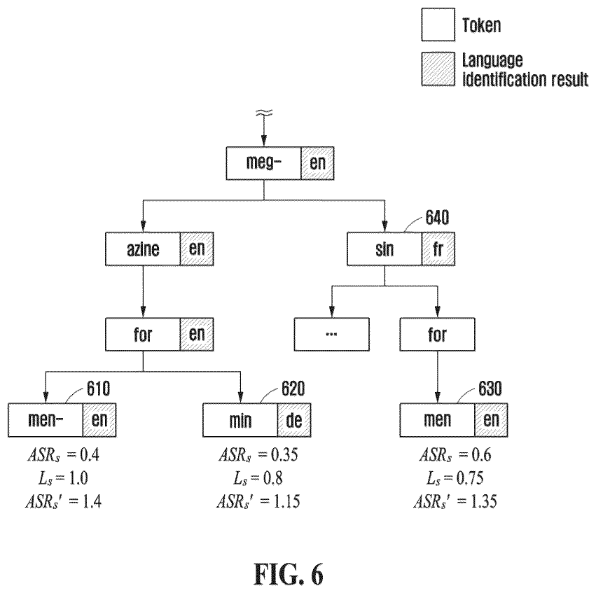

For example, referring to FIG. 6, candidate text data corresponding to speech data may include candidate text data corresponding to a first node 610, candidate text data corresponding to a second node 620, and candidate text data corresponding to a third node 630. Candidate text data corresponding to a certain node may include tokens corresponding to nodes included in a path from the root to the certain node. For example, the candidate text data corresponding to the first node 610 may correspond to “ . . . magazine for men.”

According to one or more embodiments, the candidate text data corresponding to the speech data may be determined based on an ASR score ASR_{S}. For example, the candidate text data corresponding to the first node 610, the candidate text data corresponding to the second node 620, and the candidate text data corresponding to the third node 630 may be data belonging to the top n (n is any natural number) or m % (m is any positive real number) having the high ASR score ASR_{S} among possible combinations of tokens. For example, the candidate text data corresponding to the first node 610, the candidate text data corresponding to the second node 620, and the candidate text data corresponding to the third node 630 may be data having the ASR score ASR_{S} that is greater than or equal to a predetermined threshold value.

The ASR score ASR_{S} of the candidate text data corresponding to the first node 610 may be determined to be 0.4, and an LHS L_{S} may be determined to be 1. Pieces of candidate text data corresponding to the first node 610 may be similar to each other as data indicating that the language identification results of tokens included in the path from the root to the first node 610, which is the last token, are all most likely to correspond to English, and accordingly, the LHS L_{S} may be determined to be 1.

The ASR score ASR_{S} of the candidate text data corresponding to the third node 630 may be determined to be 0.6, and the LHS L_{S} may be determined to be 0.75. The candidate text data corresponding to the third node 630 may be data indicating that the language identification results of most of the tokens included in the path from the root to the first node 610, which is the last token, are most likely to correspond to English, while referring to a fourth node 640, the language identification results of some tokens may be data indicating that the language identification results are most likely to correspond to French. Accordingly, the LHS L_{S} may be determined to be a value that is less than the LHS L_{S} of the candidate text data corresponding to the first node 610, which is data indicating that the language identification results of all tokens are most likely to correspond to English.

For example, the ASR score ASR_{S} of the candidate text data may be corrected to a value that is the sum of the ASR score ASR_{S} and the LHS L_{S}. The candidate text data corresponding to the first node 610 having the highest corrected ASR score ASR_{S}′ may be determined to be the text data corresponding to the speech data. The candidate text data corresponding to the first node 610 may be output as the speech recognition result of the speech data.

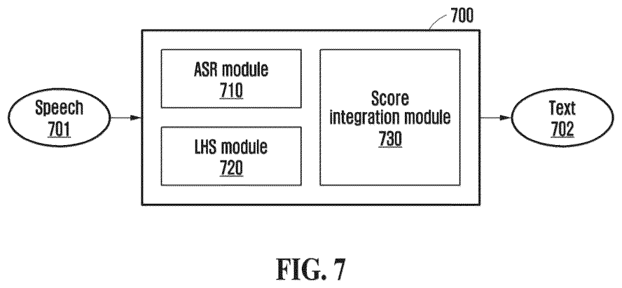

FIG. 7 is a block diagram illustrating an operation of a multilingual speech recognition apparatus, according to one or more embodiments.

According to one or more embodiments, a multilingual speech recognition apparatus 700 may be an apparatus that performs the multilingual speech recognition method described above with reference to FIGS. 1 to 6. The multilingual speech recognition apparatus 700 may be an apparatus that executes a multilingual speech recognition model.

Referring to FIG. 7, the multilingual speech recognition apparatus 700 may receive speech data 701 and output text data 702. The text data 702 may be data that converts the speech data 701 into the text form as a speech recognition result of the speech data 701. The multilingual speech recognition apparatus 700 may include an ASR module 710, an LHS module 720, and a score integration module 730. FIG. 7 illustrates a logical structure corresponding to an operation of the multilingual speech recognition method executed by the multilingual speech recognition apparatus 700 and does not limit the hardware structure of the multilingual speech recognition apparatus 700.

The ASR module 710 may be a module that determines an ASR score of a token corresponding to the speech data 701 or a token sequence. As described above, the ASR score may be determined based on the probability of which text a target token corresponds to, based on pronunciation of the speech data 701.

The LHS module 720 may be a module that determines an LHS of the token corresponding to the speech data 701 or the token sequence. As described above, the LHS may be determined based on a similarity between language identification results of tokens.

The score integration module 730 may be a module that determines the text data 702 corresponding to the speech data 701, based on the ASR score determined by the ASR module 710 and the LHS determined by the LHS module 720. As described above, the ASR score may be corrected by a sum, a weighted sum, an average, or a weighted average of the ASR score and the LHS. The score integration module 730 may obtain the corrected ASR score by calculating the sum, the weighted sum, the average, or the weighted average of the ASR score and the LHS. The text data 702 with the maximum corrected ASR score may be output as a speech recognition result of the speech data 701.

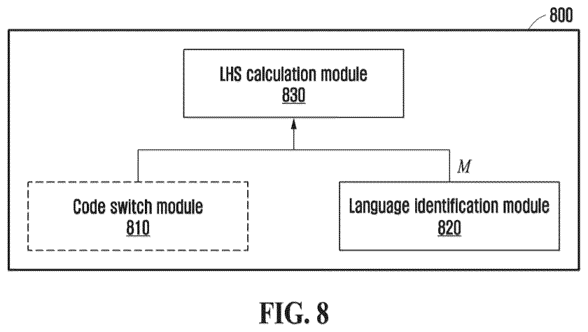

FIG. 8 is a block diagram illustrating an operation of an LHS module, according to one or more embodiments.

An LHS module 800 shown in FIG. 8 may correspond to the LHS module 720 of FIG. 7. That is, the LHS module 800 may be a module that determines an LHS of a token corresponding to input speech data or a token sequence.

Referring to FIG. 8, the LHS module 800 may include a code switch module 810, a language identification module 820, and an LHS calculation module 830. FIG. 8 illustrates a logical structure corresponding to an operation of the multilingual speech recognition method executed by the LHS module 800.

The language identification module 820 may be a module that determines a language identification result M of the token corresponding to the input speech data or the token sequence. The language identification result M may include probability data that the token or the token sequence corresponds to each recognizable language.

The code switch module 810 may be a module that determines a language change probability of the token corresponding to the input speech data or the token sequence. For example, the code switch module 810 may include a model (e.g., an n-gram model and a training model) that estimates the language change probability of the token. The code switch module 810 may output the language change probability of the token or the token sequence using the model that estimates the language change probability of the token. The LHS module 800 may or may not include the code switch module 810.

The LHS calculation module 830 may be a module that determines an LHS of the token or the token sequence based on a language identification result of the token or the token sequence obtained by the language identification module 820. According to one or more embodiments, the LHS calculation module 830 may also determine the LHS of the token or the token sequence based on the language identification result of the token or the token sequence obtained by the language identification module 820 and the language change probability of the token or the token sequence obtained by the code switch module 810.

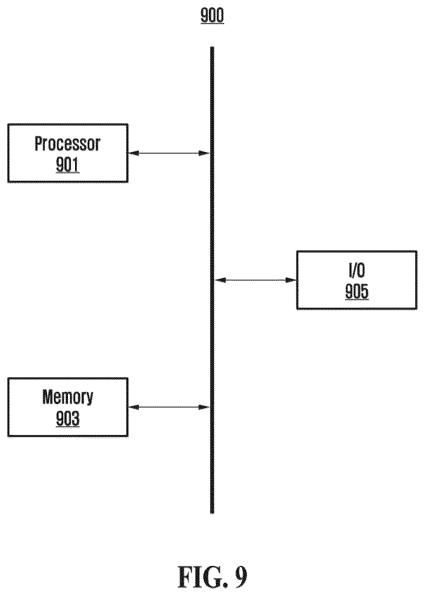

FIG. 9 is a diagram illustrating an example of a configuration of a multilingual speech recognition apparatus, according to one or more embodiments.

Referring to FIG. 9, according to one or more embodiments, a multilingual speech recognition apparatus 900 may include a processor 901, a memory 903, and an input/output (I/O) device 905. The multilingual speech recognition apparatus 900 may include an apparatus that performs the multilingual speech recognition method described above with reference to FIGS. 1 to 6. For example, the multilingual speech recognition apparatus 900 may correspond to the multilingual speech recognition apparatus 700 described above with reference to FIG. 7.

According to one or more embodiments, the processor 901 may perform at least one operation of the multilingual speech recognition method described above with reference to FIGS. 1 to 6.

For example, the processor 901 may perform at least one of determining an LHS of a target token based on a language identification result of the target token obtained as a speech recognition result of input speech data and determining text data corresponding to the input speech data, based on the LHS of the target token and a probability that the target token corresponds to the input speech data.

For example, the processor 901 may perform at least one of obtaining pieces of candidate text data corresponding to the input speech data, based on a speech recognition result of the input speech data, determining LHSs of the pieces of candidate text data based on a similarity between language identification results of a plurality of tokens included in the pieces of candidate text data, and determining, among the pieces of candidate text data, the text data corresponding to the input speech data, based on the LHSs of the pieces of candidate text data.

According to one or more embodiments, the memory 903 may be a volatile memory or a non-volatile memory and may store data related to the multilingual speech recognition method described above with reference to FIGS. 1 to 6. For example, the memory 903 may store data generated during the process of performing the multilingual speech recognition method or data that is necessary for performing the multilingual speech recognition method. For example, the memory 903 may store at least one of a language identification result of a token or a token sequence, an LHS of the token or the token sequence, and an ASR score of the token or the token sequence.

According to one or more embodiments, the memory 903 may store a program in which the multilingual speech recognition method described above with reference to FIGS. 1 to 6 is implemented. The processor 901 may execute a program stored in the memory 903 and control the multilingual speech recognition apparatus 900. Code of the program executed by the processor 901 may be stored in the memory 903.

According to one or more embodiments, the multilingual speech recognition apparatus 900 may be connected to an external device (e.g., a personal computer (PC) or a network) through the I/O device 905 and exchange data therewith. For example, the multilingual speech recognition apparatus 900 may receive speech data through the I/O device 905 and output text data as a speech recognition result of the speech data.

According to one or more embodiments, the multilingual speech recognition apparatus 900 may further include other components not shown in the drawings.

For example, the multilingual speech recognition apparatus 900 may include a communication module. The communication module may provide a function for the multilingual speech recognition apparatus 900 to communicate with other electronic devices or other servers through a network. According to one or more embodiments, the memory 903 may not be a component of the multilingual speech recognition apparatus 900 but may be included in an external device accessible by the multilingual speech recognition apparatus 900. In this case, the multilingual speech recognition apparatus 900 may receive data stored in the memory 903 included in the external device through the communication module and may transmit data to be stored in the memory 903.

In another example, the multilingual speech recognition apparatus 900 may further include other components such as a transceiver, various sensors, a database, etc.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Accordingly, other implementations are within the scope of the following claims.

What is claimed is:

1. A multilingual speech recognition method comprising:
determining a language homogeneity score (LHS) of a target token based on a language identification result of the target token, wherein the target token is obtained as a speech recognition result of input speech data; and
identifying text data corresponding to the input speech data based on the LHS of the target token and a probability that the target token corresponds to the input speech data.

2. The multilingual speech recognition method of claim 1, wherein the identifying the text data corresponding to the input speech data comprises:
determining an automatic speech recognition (ASR) score of the target token based on the probability that the target token corresponds to the input speech data;
correcting the ASR score of the target token based on the LHS of the target token; and
identifying the text data corresponding to the input speech data based on the ASR score of the target token.

3. The multilingual speech recognition method of claim 1, wherein the determining the LHS of the target token comprises determining the LHS of the target token based on a degree of similarity between the language identification result of the target token and a language identification result of a token sequence prior to the target token.

4. The multilingual speech recognition method of claim 1, wherein the determining the LHS of the target token comprises determining the LHS of the target token based on a degree of similarity between the language identification result of the target token and a language identification result of the input speech data.

5. The multilingual speech recognition method of claim 1, wherein the determining the LHS of the target token comprises:
determining a parameter regarding a proportion of the LHS of the target token based on a language change probability corresponding to the target token; and
correcting the LHS of the target token based on the parameter.

6. The multilingual speech recognition method of claim 5, wherein the parameter decreases as the language change probability of the target token increases.

7. A multilingual speech recognition method comprising:
obtaining pieces of candidate text data corresponding to input speech data based on a speech recognition result of the input speech data;
determining a language homogeneity score (LHS) of each of the pieces of candidate text data based on a degree of similarity between language identification results of a plurality of tokens included in the pieces of candidate text data; and
identifying, based on the LHSs of the pieces of candidate text data, one or more pieces of candidate text data corresponding to the input speech data from among the pieces of candidate text data.

8. The multilingual speech recognition method of claim 7, wherein the determining the LHS of each of the pieces of candidate text data comprises:
determining, for each of the plurality of tokens included in the pieces of candidate text data, an LHS of the token; and
determining the LHS of each of the pieces of candidate text data based on a sum of the LHSs of the plurality of tokens.

9. The multilingual speech recognition method of claim 8, wherein the determining the LHS of each of the plurality of tokens comprises determining, for each of the plurality of tokens, an LHS of the token based on a degree of similarity between a language identification result of the token and a language identification result of a token sequence prior to the token.

10. The multilingual speech recognition method of claim 8, wherein the determining the LHSs of each of the plurality of tokens comprises determining, for each of the plurality of tokens, an LHS of the token based on a degree of similarity between a language identification result of the token and a language identification result of the input speech data.

11. The multilingual speech recognition method of claim 7, wherein the identifying the one or more pieces of candidate text data corresponding to the input speech data comprises identifying, among the pieces of candidate text data, the one or more pieces of candidate text data corresponding to the input speech data based on respective probabilities that each of the pieces of candidate text data corresponds to the input speech data and the respective LHS of each of the pieces of candidate text data.

12. The multilingual speech recognition method of claim 7, wherein the determining the LHS of each of the pieces of candidate text data comprises:
determining, for each of the pieces of candidate text data, a parameter regarding a proportion of the LHS of the piece of candidate text data based on a language change probability corresponding to each token of the plurality of tokens included in the piece of candidate text data; and
correcting the LHS of each of the pieces of candidate text data based on the determined parameters.

13. The multilingual speech recognition method of claim 12, wherein the parameter corresponding to a given piece of candidate text data among the pieces of candidate text data decreases as the language change probability of each token of the plurality of tokens included in the given piece of candidate text data increases.

14. A non-transitory computer-readable storage medium having instructions stored therein, which when executed by at least one processor, cause the at least one processor to execute the multilingual speech recognition method of claim 1.

15. A multilingual speech recognition apparatus comprising:
at least one memory storing one or more instructions; and
at least one processor configured to execute the one or more instructions,
wherein the one or more instructions, when executed by the at least one processor, cause the multilingual speech recognition apparatus to:
determine a language homogeneity score (LHS) of a target token based on a language identification result of a target token obtained as a speech recognition result of input speech data, and
identify text data corresponding to the input speech data based on the LHS of the target token and a probability that the target token corresponds to the input speech data.

16. The multilingual speech recognition apparatus of claim 15, wherein the one or more instructions, when executed by the at least one processor, cause the multilingual speech recognition apparatus to, in the identification of the text data corresponding to the input speech data:
determine an automatic speech recognition (ASR) score of the target token based on the probability that the target token corresponds to the input speech data,
correct the ASR score of the target token based on the LHS of the target token, and
identify the text data corresponding to the input speech data based on the ASR score of the target token.

17. The multilingual speech recognition apparatus of claim 15, wherein the one or more instructions, when executed by the at least one processor, cause the multilingual speech recognition apparatus to, in the determination of the LHS of the target token, determine the LHS of the target token based on a degree of similarity between the language identification result of the target token and a language identification result of a token sequence prior to the target token.

18. The multilingual speech recognition apparatus of claim 15, wherein the one or more instructions, when executed by the at least one processor, cause the multilingual speech recognition apparatus to, in the determination of the LHS of the target token, determine the LHS of the target token based on a degree of similarity between the language identification result of the target token and a language identification result of the input speech data.

19. The multilingual speech recognition apparatus of claim 15, wherein the one or more instructions, when executed by the at least one processor, cause the multilingual speech recognition apparatus to, in the determination of the LHS of the target token:
determine a parameter regarding a proportion of the LHS of the target token, based on a language change probability corresponding to the target token, and
correct the LHS of the target token based on the parameter.

20. A non-transitory computer-readable storage medium having instructions stored therein, which when executed by at least one processor, cause the at least one processor to execute the multilingual speech recognition method of claim 7.
